(19) United States
(12) Patent Application Publication
(10) Pub. No.: US 2006/0079387 A1
(43) Pub. Date: Apr. 13, 2006

(54) High homogeneity silica glass prepared through a sol-gel procedure

(76) Inventors: Fulvio Costa, Sommo (PV) (IT); Lorenzo Costa, Sommo (PV) (IT); Massimo Sparpaglione, S. Donato Milanese (IT)

Correspondence Address: FITCH, EVEN, TABIN & FLANNERY, P. O. BOX 65973, WASHINGTON, DC, 20035, US

(21) Appl. No.: 10/549,680

(22) PCT Filed: Mar. 12, 2004
(86) PCT No.: PCT/EP04/02577

§ 371 Date: Sep. 19, 2005

(30) Foreign Application Priority Data
Mar. 21, 2003 (IT) NO2003A000005

(51) Int. Cl. C03B 8/02; C03C 3/04

(52) U.S. Cl. 501/12; 65/17.2

(57) ABSTRACT

The present invention relates to a Si₂O glass characterized by a high homogeneity, prepared through a sol-gel procedure.

The present invention relates to a highly homogeneous Si₂O glass prepared through a sol-gel procedure.

The sol-gel term defines a wide variety of processes which, even if being different as for as the working details or the reagents are concerned, are characterized by the following common operations:
preparation of a solution, or a suspension, of a precursor formed by a compound of the element (M) the oxide of which has to constitute the final glassy article;
hydrolysis, acid or base catalyzed, of the precursor, inside the solution or suspension, to form M-OH groups according to the reaction
   MXn+nH₂O→M(OH)ₙ+nHX
wherein X generally is an alcohol residue and n means the element M valence; the alcoxydes M(OR)n can be replaced by soluble salts of the element M such as chlorides or nitrates, and, in some cases, oxyides. The obtained mixture, i.e. a solution or a colloidal suspension, is named sol;
polycondensation of the M-OH groups according to the reaction
   M—OH+M—OH→M—O—M+H₂O
which requires a time from few seconds to some days, depending on the solution composition and the temperature; during this step, a matrix is formed called, case by case, alcohogel, hydrogel or more generally, gel;
gel drying till the formation of a porous monolithic body; during this step, the solvent is removed through a simple controlled evaporation, which determines the so called xerogel, or through an extraction in autoclave which determines the so called aerogel; the obtained body is a porous glass, which may have an apparent density of 10% to about 50% of the theoric density of the oxide having the same composition; the dried gel can be industrially used as such;
densification of the dried gel by a treatment at a temperature, generally ranging between 800° C. and 1500° C., depending on the gel chemical composition and the preceding step process parameters; during this step the porous gel is becoming dense, under a controlled atmosphere, till to obtain a glassy or ceramic compact oxide having the theoric density, with a linear shrinkage equal to about 50%.

The final densification let a glassy product be obtained having good general characteristics, and, however, without any such optical homogeneity property to let the material be crossed by the transmitted light wave front without any suffered distortion.

The Applicant has found that in the case suitable treatments under controlled atmosphere are carried out during the densification stage, the final glassy product is obtained having no streak and strip, the same being consequently characterized by an almost total homogeneity.

Therefore, the object of the present invention is a silica glass characterized, inter alia, by the following specific properties:
light internal transmittance in the wave length between 185 nm and 193 nm higher than 85%
light internal transmittance in the wave length between 193 nm and 2600 nm higher than 99.5%
light internal transmittance in the wave length between 2600 nm and 2730 nm higher than 99%
light internal transmittance in the wave length between 2730 nm and 3200 nm higher than 85%
no streak, material of class 4 or better according to the rule DIN ISO 10110-4
no strip
no signal in the shadography (no shadow or intensity change)
   such a silica glass being prepared according to a sol-gel process wherein, in the meanwhile the densification is achieved, a treatment is carried out by means of an atmosphere containing water traces.

1. (canceled)

2. A silica glass characterized by the following specific properties:
a) light internal transmittance in the wave length between 185 nm and 193 nm higher than 85%;
b) light internal transmittance in the wave length between 193 nm and 2600 nm higher than 99.5%;
c) light internal transmittance in the wave length between 2600 nm and 2730 nm higher than 99%;
d) light internal transmittance in the wave length between 2730 nm and 3200 nm higher than 85%;
e) no streak, material of class 4 or better according to the rule DIN ISO 10110-4;
f) no strip;
g) no signal in the shadography (no shadow or intensity change);
and wherein said silica glass is made by a sol gel process.

3. The silica glass of claim 2, wherein said sol gel process includes a step in which said sol gel is thermally treated at a temperature of 800° C.-1500° C. to increase its density.

4. The silica gel of claim 3, wherein thermal treatment is carried out in a controlled atmosphere containing traces of water.

5. The silica gel of claim 4, wherein said sol gel process further comprises the steps of:
a) preparing a sol from a silicon alcoxide;
b) allowing or inducing the hydrolysis of the sol prepared in step a);
c) drying the gel obtained in step b).
